(19) United States
(12) Patent Application Publication
(10) Pub. No.: US 2013/0003183 A1
(43) Pub. Date: Jan. 3, 2013

(54) OPTICAL ELEMENT

(75) Inventor: Takeshi HIDAKA, Tokyo (JP)

(73) Assignee: OLYMPUS CORPORATION, Tokyo (JP)

(21) Appl. No.: 13/612,232

(22) Filed: Sep. 12, 2012

Related U.S. Application Data
(63) Continuation of application No. PCT/JP2011/056402, filed on Mar. 17, 2011.

(30) Foreign Application Priority Data
Apr. 22, 2010 (JP) 2010-098867

(51) Int. Cl. G02B 1/11; B32B 3/10; B44C 1/22

(52) U.S. Cl. 359/601; 216/24; 428/174

(57) ABSTRACT

The present invention provides an optical element including, at least partially, a fine concavo-convex structure including a convex part in which an edge line part runs continuously in a net-like manner, in which at least a part of the edge line part is formed to be deeper in a depth direction of the concave part than an edge line intersection part at which the edge line part intersects.

### CROSS-REFERENCE TO RELATED APPLICATION

This is a Continuation Application of PCT Application No. PCT/JP2011/56402, filed Mar. 17, 2011, which was not published under PCT Article 21(2) in English.

This application is based upon and claims the benefit of priority from prior Japanese Patent Application No. 2010-098867, filed Apr. 22, 2010, the entire contents of which are incorporated herein by reference.

### BACKGROUND OF THE INVENTION

1. Field of the Invention

The present invention relates to an optical element.

2. Description of the Related Art

For example, on an optical surface of an optical element, reflected light of a several percent with respect to incident light is generated, and an anti-reflection structure has been provided for purposes such as to improve the transmissivity and to reduce optical noise due to the reflected light.

For example, Patent Document 1 discloses a technique to form an anti-reflection film by transferring a fine concavo-convex pattern arranged independently with a predetermined pitch on to a surface into light-permeable plastic and the like by a stamper, to provide an anti-reflection effect.

### Prior Art Document

[Patent Document 1] Japanese Laid-open Patent Publication No. 2003-43203

### SUMMARY OF THE INVENTION

The first aspect of the present invention provides an optical element including, at least partially, a fine concavo-convex structure comprising a convex part in which an edge line part runs continuously in a net-like manner, in which at least a part of the edge line part is formed to be deeper in a depth direction of the concave part than an edge line intersection part at which the edge line part intersects.

The second aspect of the present invention provides an anti-reflection structure including a fine concavo-convex structure comprising a convex part in which an edge line part runs continuously in a net-like manner, in which at least apart of the edge line part is formed to be deeper in a depth direction of the concave part than an edge line intersection part at which the edge line part intersects.

The third aspect of the present invention provides a manufacturing method of an optical element, including: a process to cover an optical surface with a mask having a plurality of openings; a process to form a plurality of concave parts on the optical surface corresponding to the openings by isotropic etching; and a process to apply etching further so that, in a convex part in which an edge line part runs continuously and encloses the concave part, at least apart of the edge line part becomes deeper in a depth direction of the concave part than an edge line intersection part at which the edge line part intersects.

According to the prevent invention, a technique that makes it possible to reduce the flat part of the topmost surface of an optical element to improve the optical performance such as the anti-reflection performance may be provided.

### BRIEF DESCRIPTION OF THE DRAWINGS

FIG. 1 is a plane diagram presenting an enlarged view of a part of the optical element being an embodiment of a present invention.

FIG. 2 is a cross-sectional diagram presenting an enlarged view of a part of the optical element being an embodiment of a present invention.

FIG. 3 is an oblique perspective diagram presenting an enlarged view of a part of the optical element being an embodiment of a present invention.

FIG. 4 is an approximate cross-sectional diagram presenting an enlarged view of a halfway condition while forming a fine concavo-convex structure formed in an optical element being an embodiment of the present embodiment.

FIG. 5 is an oblique perspective diagram presenting a configuration example of an optical element being an embodiment of the present invention.

FIG. 6 is an oblique perspective diagram presenting another configuration example of an optical element being an embodiment of the present invention.

### DESCRIPTION OF EMBODIMENTS

In an aspect of the embodiment of the present invention, in a fine concavo-convex structure formed continuously in a net-like manner, the edge line intersection of the convex part that forms the edge line area enclosing the convex part is formed higher than the edge line part of between the edge line intersection parts. In other words, the height of the edge line part between the edge line intersection parts is made lower than the edge line intersection part.

Accordingly, the flat part of the topmost surface part from which light enters may be reduced, making it possible to obtain the anti-reflection effect more efficiently.

Hereinafter, with reference to the drawings, the embodiment of the present embodiment is explained in detail.

Meanwhile, in the explanation of the present embodiment below, it is assumed that each of the X, Y, Z directions is as illustrated in each drawing.

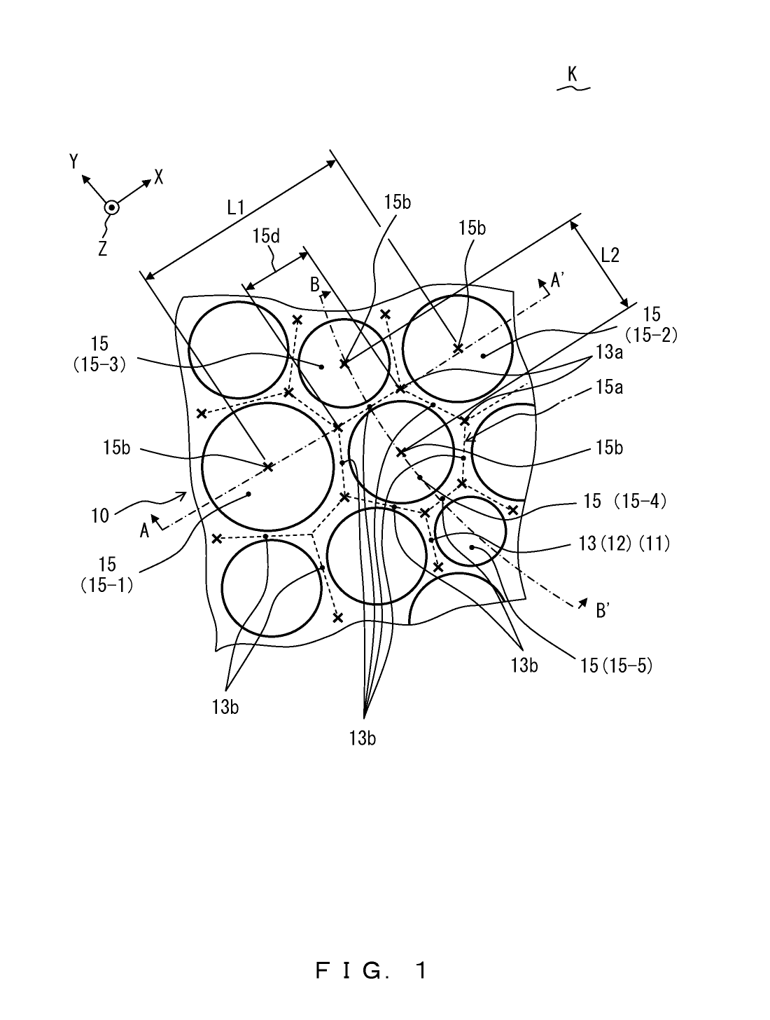

FIG. 1 is a plane diagram presenting an enlarged view of a part of the optical element being an embodiment of a present invention.

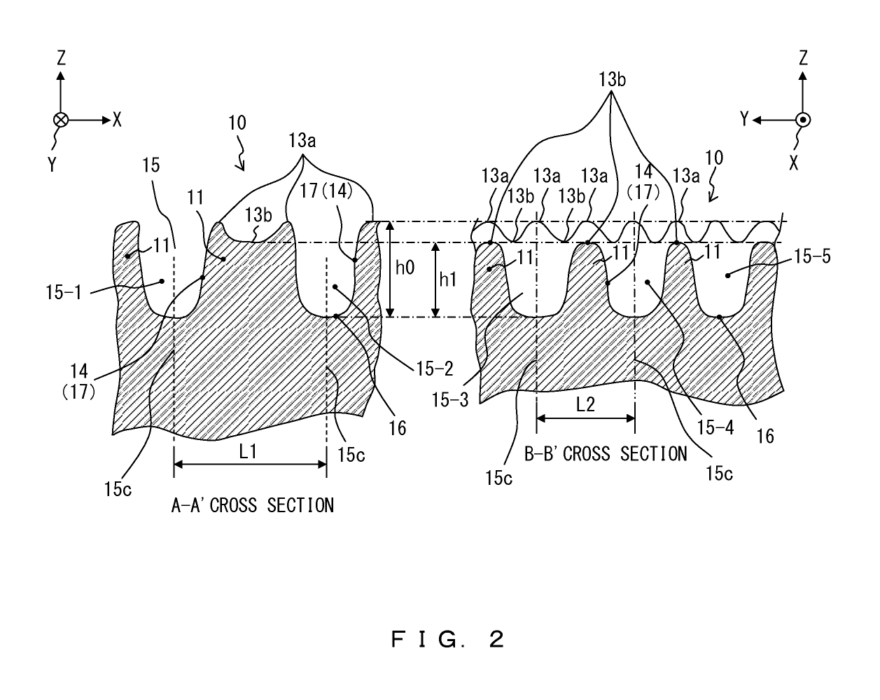

FIG. 2 is a cross-sectional diagram presenting an enlarged view of a part of the optical element being an embodiment of a present invention.

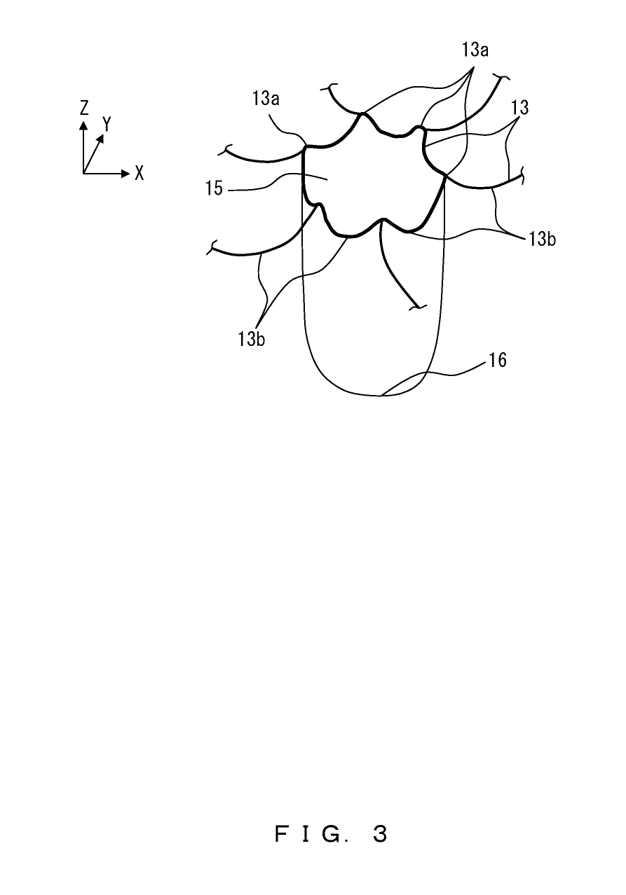

FIG. 3 is an oblique perspective diagram presenting an enlarged view of a part of the optical element being an embodiment of a present invention.

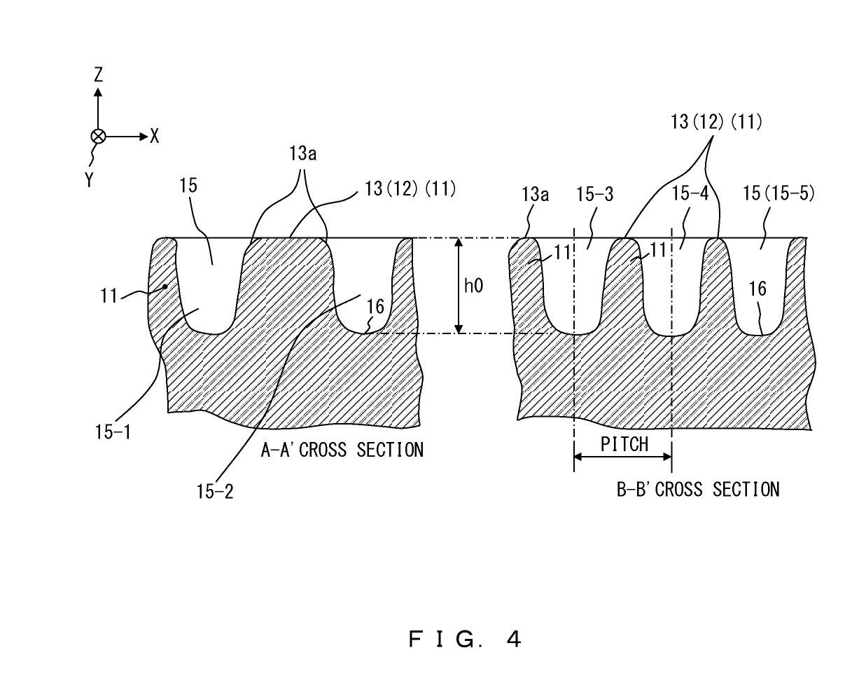

FIG. 4 is an approximate cross-sectional diagram p resenting an enlarged view of a halfway condition while forming a fine concavo-convex structure formed in an optical element being an embodiment of the present embodiment.

Meanwhile, in FIG. 2, the cross sections at the line A-A′ and at the line B-B′ are presented side by side with reference to the deepest portion of the concave part.

In addition, on the left side of FIG. 2, only the cross sectional part at the line A-A′ is presented, and in the cross sectional diagram at the line B-B′ on the right, the outline of the edge line part in the back is also presented.

In addition, FIG. 3 illustrates a wire frame model representing the height distribution in the Z direction of the continuous concavo-convex shape in the net-like manner.

As illustrated in FIG. 1 and FIG. 2, in the optical element K of the present embodiment, a fine concavo-convex structure 10 is formed on at least a part of a surface such a s an optical function surface.

The fine concavo-convex structure 10 of the present embodiment has a configuration in which a plurality of concave parts 15 are arranged so as to be enclosed by a continuo us convex part 11 in a net-like manner along an edge line part 13 being a line of convex peak parts 12.

In this case, as illustrated in FIG, 1, the convex peak part 12 is at the position of the broken line at the border of adjacent concave parts 15. That is, the convex peak part 12 is the peak part of the convex part 11 that is positioned between adjacent concave parts 15.

For example, when the optical surface of the optical element K on which the fine concavo-convex structure 10 is located and formed is a flat surface, the X-Y plane that is parallel to the optical surface is the surface on which the concave part 15 is arranged, and the depth direction of the concave part 15 (that is, the normal direction of the optical plane) is the Z direction.

Meanwhile, when the optical surface of the optical element K is a curved surface, the X-Y surface is a tangent plane, and the Z direction is the normal direction of the optical surface.

In the case of the fine concavo-convex structure 10, an edge curve surface 14 (that is, an inner periphery 17 of the concave part 15) split from the edge line part 13 of the convex part 11 is convex outward, that is, toward the concave part 15 side, and the width dimension of the cross section of the convex part 11 is increasing in a curve in the depth direction of the concave part 15.

That is, the shape of the cross section of the concave part 15 enclosed by the continuous convex part 11 is, for example, an approximate cone shape tapering toward a concave part deepest portion 16, for example.

Thus, in the fine concavo-convex structure 10, little flat part that is parallel to the X-Y plane exists on the boundary part between adjacent concave parts 15, and only the edge curve surface 14 that sinks inside adjacent concave parts 15 across the continuous edge line part 13 in a net-like manner being a line of the convex peak parts 12 of the convex part 11, which totally differs from a structure in which holes are simply arranged and formed in a discrete manner on the X-Y plane being the surface for the arrangement. Then, the edge curve surface 14 of the convex part 11 becomes the inner periphery 17 of the concave part 15 in the structure.

Then, in the case of the present embodiment, at least a part of the edge line part 13 of the convex part 11 is formed to be deeper in the depth direction of the concave part 15 than an edge line intersection 13a (edge line intersection part).

That is, height h1 from the edge line part deepest portion 13b to the concave part deepest portion 16 is lower than the height h0 from the edge line intersection 13a to the concave part deepest portion 16.

In other words, the forming position of the edge line part deepest portion 13b in the edge line part 13 of the convex part 11 is on a shallower place than the concave part deepest portion 16 of the concave part 15.

Thus, in the case of the present embodiment, as illustrated in FIG. 3, the edge line part 13 of the convex peak part 12 is not flat in the length direction as illustrated in FIG. 3, and the area between given two edge line intersections 13a is in a shape of an approximate saddle shape surface sloped downward from the highest and most sharply protruding edge line intersection 13a (height h0) to the edge line part deepest portion 13b (height h1).

Then, when the optical surface on which the fine concavo-convex structure 10 is placed is a flat surface, the envelop plane of the edge line intersection 13a at the highest position of the fine concavo-convex structure 10 becomes the flat surface, and when the optical surface is a curved surface, the envelop plane of the edge line intersection 13a of the fine concavo-convex structure 10 becomes the curved surface.

A line that goes through the center of the concave part 15 (a precise definition in the present embodiment is described later) and is parallel to the Z direction is a center line 15c of the concave part 15.

Then, when the target to realize anti reflection by the fine concavo-convex structure 10 of the present embodiment is visible light (wavelength A=380 nm-780 nm) for example, maximum value Lmax of distance L1 of center lines 15c of the concave parts 15 positioned on both ends of a line segment connecting give two adjacent edge line intersections 13a (in the example in FIG. 1, distance L1 between the concave part 15-1 and the concave part 15-2) is set as Lmax<λ.

In addition, distance L2 of center lines 15c of adjacent concave parts 15 across the edge line part 13 (edge line part deepest portion 13b) (in the example in FIG. 1, the concave part 15-3 and the concave part 15-4) is smaller than the distance L1 (L2<L1).

Here, with reference to FIG. 1, an example of a method to evaluate sizes and variation of respective parts in the fine concavo-convex structure 10 of the present embodiment is explained.

While the example in FIG. 1 described above illustrates a case in which the shape of the cross section on the plane parallel to the X-Y plane of the respective concave part 15 is an approximate round shape, it may be any closed curve figure such as the shape of an ellipse, a cocoon, a comma, and the like, for example.

In addition, while the outline of the concave part 15 is illustrated with a circular solid line in FIG. 1 for convenience of illustration, the concave part 15 is formed by the inner periphery 17 (edge curve surface 14) being a continuous curved surface from the edge line part 13 of the convex part 11 in the surroundings to the concave part deepest portion 16.

In this present embodiment, as an example, as illustrated in FIG. 1, the center of the concave part 15 in a give n shape is defined as the center of gravity 15b of a polygon 15a whose vertices are all edge line intersections 13a where the edge line part 13 of the convex part 11 surrounding the concave part 15 intersects. Then, the center line 15c is a line segment that goes through the center of gravity and is parallel to the Z direction.

Therefore, the distances L1 and L2 described above are the distance between the centers of gravity of figures that characterize the relevant concave part 15.

In the fine concavo-convex structure 10 of the present invention, the size of the shape of the concave parts 15 (in this case, the size and shape of the polygon 15a, or the positional relation of the concave parts 15) may be varied a s needed, to arrange the fine concavo-convex structure 10 evenly.

Meanwhile, for the arrangement in the X-Y plane of the concave parts 15 in various sizes, a dense triangular-stack arrangement and the like may be used.

In addition, as an index to evaluate the variation of the size, shape, arrangement position relationship and the like of the concave parts 15 in the fine concavo-convex structure 10, in the present embodiment, as an example, the variation of the distance 15d between edge line intersections of the polygon 15a.

Next, an example of the method of forming the fine concavo-convex structure 10 of the present embodiment is explained. First, an optical surface of an optical element K on which the fine concavo-convex structure 10 should be formed is covered by mask pattern on which the position to arrange the concave part 15 is selectively opened.

After that, etching is applied to the optical surface by isotopic etching, to form the concave part 15 of a desired depth. At this time, the erosion advances in the width direction to the under side of the mask pattern as well, and the convex part 11 having a convex peak part 12 with a bell-shaped cross section shape is formed directly beneath the mask pattern between the concave parts 15.

This halfway condition is in FIG. 4, where the height of the convex part 11 (edge line part 13) enclosing the concave part 15 from the concave part deepest portion 16 (that is, the depth of the concave part 15) is the height h0 approximately evenly in the entirety of the edge line part 13. Meanwhile, FIG. 4 presents the cross section of the same part as in FIG. 2.

In the case of the present embodiment, from the condition in FIG. 4, etching is performed further until the edge line part deepest portion 13b is formed between the edge line intersections 13a as in FIG. 2 described above.

That is, the thickness of the convex part 11 enclosing the concave part 15 is thinnest in the middle part of adjacent edge line intersections 13a. Therefore, the reduction in the height of the convex peak part 12 (edge line part 13) by the etching advances most quickly in the middle part of the edge line intersections 13a, and the edge line part 13 between the edge line intersections 13a is eroded to have an approximate saddle shape, to form the edge line part deepest portion 13b of the height h1 (<the height h0) as illustrated in FIG. 2 described above.

Meanwhile, as a method to form the fine concavo-convex structure 10 with respect to a given optical element K, while the formation may be done by applying the etching described above and the like directly on the optical surface of the optical element K, the formation may also be done by preparing a molding tool having an inverted concavo-convex Shape of the fine concavo-convex structure 10, and by transferring the fine concavo-convex structure 10 on to the optical element K from the molding tool.

Thus, in the optical element K of the present embodiment, in the edge line part 13 of the convex peak part 12 enclosing the concave part 15, the edge line part deepest port ion 13b having the height h1 that is lower than the height h0 from the concave part deepest portion 16 is formed between the edge line intersection 13a, so the edge line part 13 is not flat in the length direction.

For this reason, the anti-reflection effect of light in the fine concavo-convex structure 10 is further improved.

In addition, since the maximum value of the distance L1 of the center parts of adjacent concave parts is made smaller than the wavelength λ of visible light, and at least one of the shape and the size of the concave part 15 is formed randomly, a large anti-reflection effect on visible light may be realized.

According to the above, in the fine concavo-convex structure 10 of the optical element K, it becomes possible to reduce the flat part of the topmost surface part from which light enters, and to improve the optical performance such as the anti-reflection performance.

That is, about the optical element K with the surface on which the fine concavo-convex structure 10 is formed, it becomes possible to reduce the flat part of the topmost surface, and to improve the optical performance such as the anti-reflection performance.

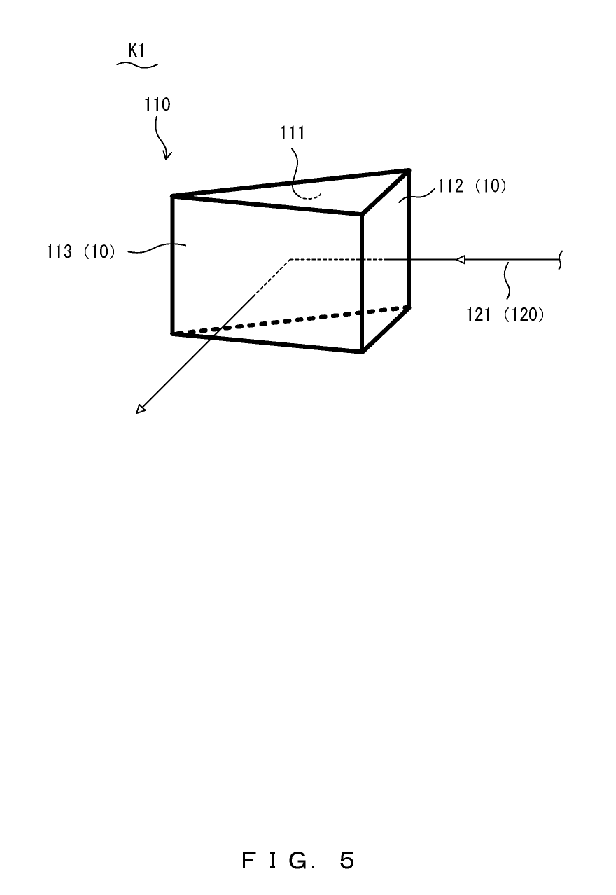

FIG. 5 is an oblique view diagram presenting a configuration example of an optical element being an embodiment of the present invention.

FIG. 5 illustrates a case of a prism 110 as an example of an optical element K1 having the fine concavo-convex structure 10 described above.

In this prism 110, on each of the three faces of the triangle prism, a reflection coat forming plane 111, an incident plane 112, an exit plane 113 are arranged.

The reflection coat forming plane 111 is a reflection surface of an aluminum cover layer, for example.

Then, as illustrated by optical path 121 of light 120, the light 120 entering from the incident plane 112 is reflected on the reflection coat forming plane 111, and is out put from the exit plane 113.

On each surface of the incident plane 112 and the exit plane 113, the fine concavo-convex structure 10 is formed.

In this case, the respective planes, the incident plane 112 and the exit plane 113, are the X-Y plane in the fine concavo-convex structure 10 described above, and are in the positional relationship in which the normal direction is the Z direction.

According to the prism 110 being the optical element K1 having the fine concavo-convex structure 10 formed on the surfaces such of the incident plane 112 and the exit plane 113, a high anti-reflection effect is realized, and a high optical performance may be realized,

Furthermore, when the fine concavo-convex structure 10 is provided, since the convex part 11 enclosing the concave part 15 is formed continuously so that the edge line part 13 being a line of its convex peak part 12 is continuous in a net-like manner, the strength of the convex part 11 against the external force is significantly improved, compared with a shape in which the convex part is formed by itself in isolation.

Furthermore, in the present embodiment, as an example, by making the maximum value of the distance L1 describe d above equal to or smaller than the wavelength ? of visible light, the anti-reflection effect of the fine concavo-convex structure 10 with respect to visible light is realized more prominently.

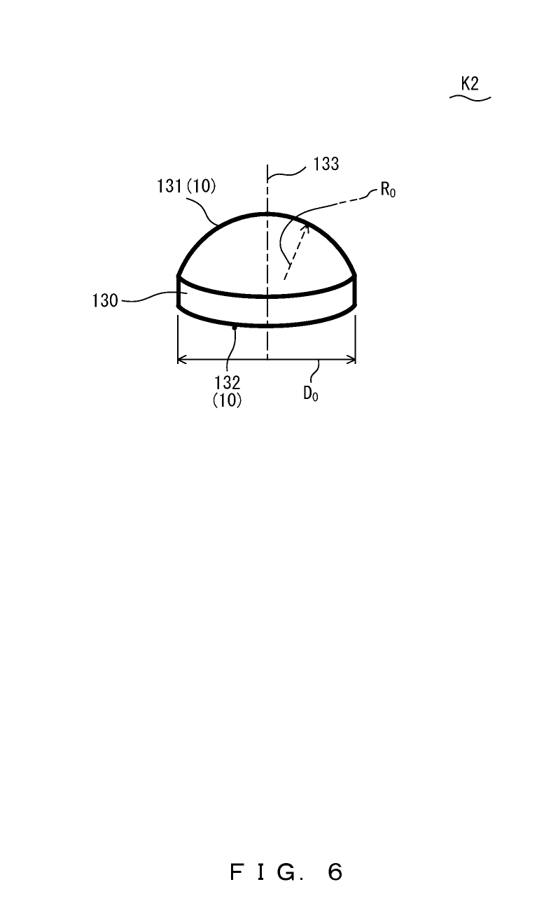

FIG. 6 is an oblique view diagram illustrating another configuration example of an optical element of the present invention.

An optical element K2 illustrated in FIG. 6 is a plano-convex lens 130 having a convex optical surface 131 being a spherical surface whose effective diameter D0 is 5.4 mm, curvature radius R0 is 3.5 mm as the first surface, and a plain optical surface 132 as the second surface.

Then, on the a convex optical surface 131 being the first surface, the fine concavo-convex structure is 10 described above is formed.

Meanwhile, as needed, the fine concavo-convex structure 10 may also be formed on the plain optical surface 132.

In this case, since the convex optical surface 131 on which the fine concavo-convex structure 10 is a curved surface, the fine concavo-convex structure 10 is formed so that the normal direction of the convex optical surface 131 becomes the Z direction described above (the direction of the center line 15c of the concave part 15).

In this case, the size and arrangement condition of the concave part 15 may be determined according to the design shape of the convex optical surfaces 131, so that an anti-reflection effect may be obtained evenly on the entire surface of the convex optical surface 131 of a curved surface an d without generating anisotropy.

That is, parameters such as the height h0 of the edge line intersection 13a, the height h1 of the edge line part deepest portion 13b, furthermore, the distance L1, the distance L2, the standard deviation of the distance 15d between the edge line intersections described above regarding the concave part 15 and the like area set.

According to this optical element K2, by forming the fine concavo-convex structure 10 on the surface, the influence by the flat part on the topmost surface part from which light enters may be canceled to realize a high anti-reflection effect.

Furthermore, by making the maximum value of the distance L1 described above equal to or smaller than the wavelength λ of visible light, the optical element K2 that realizes the anti-reflection effect of the fine concavo-convex structure 10 more prominently with respect to visible light beam may be provide.

That is, since the fine concavo-convex structure 10 is formed on the convex optical surface of the plano-convex lens 130 being the optical element K2, the optical element K2 equipped with an anti-reflection effect and a high light transmissivity with respect to the visible light wavelength may be provided, and in addition, the incident light may be collected efficiently.

Thus, it becomes possible to apply the plano-convex lens 130 having the fine concavo-convex structure 10 to various optical systems, since the incident light may be collected efficiently.

Meanwhile, in an optical system, by placing the optical element K1 and the optical element K2 of the present embodiment especially at a position from which light enters, such as the first surface on the incidence side, it becomes possible to build an optical system having a high anti-reflection performance, since the anti-reflection effect may be obtained more efficiently in the optical surface.

While the plano-convex lens 130 in which one side is the convex optical surface 131 and another side is the plain optical surface 132 has been illustrated as the optical element K2, both sides may be a curved surface, or as long as it is a curved surface shape, any curved surface such as a spherical surface, an aspheric surface, a free-form surface is fine. In addition, it may be a concave lens in which the optical surface on which the fine concavo-convex structure 10 is formed is a concave surface.

In addition, while the depth direction in which the fine concavo-convex structure 10 is arranged and formed is illustrated as the normal direction of the optical surface, according to the required optical performance, it does not have to be formed in the normal direction of the optical surface.

In addition, while the shape of the cross section of the concave part enclosed by the continuous convex part is illustrated as a tapering approximate cone shape, the shape may also be a cylinder shape, a bell shape and the like.

Furthermore, as the optical element K having the fine concavo-convex structure 10, application may be made not only to the lens, the prism and the like described above, but also various constituent elements of an optical system such as a panel, a film, a thin film, the wall of a lens tube and the like.

Meanwhile, it goes without saying that the present invention is not limited to the configurations illustrated in the embodiments above, and various changes may be made without departing from its gist.

What is claimed is:

1. An optical element comprising, at least partially, a fine concavo-convex structure comprising a convex part in which an edge line part runs continuously in a net-like manner, in which at least a part of the edge line part is formed to be deeper in a depth direction of the concave part than an edge line intersection part at which the edge line part intersects.

2. The optical element according to claim 1, wherein
a concave part deepest portion being a deepest in the concave part is formed to be deeper than an edge line part deepest portion of being a deepest in the edge line part.

3. The optical element according to claim 1, wherein
in the fine concavo-convex structure, a maximum value of a distance of center parts of the two concave parts adjacent in a direction connecting the two adjacent edge line intersection parts is smaller than visible light wavelength.

4. The optical element according to claim 2, wherein
in the fine concavo-convex structure, a maximum value of a distance of center parts of the two concave parts adjacent in a direction connecting the two adjacent edge line intersection parts is smaller than visible light wavelength.

5. The optical element according to claim 1, wherein
the fine concavo-convex structure is formed so that at least one of a shape and a size of the concave part is random.

6. The optical element according to claim 2, wherein
the fine concavo-convex structure is formed so that at least one of a shape and a size of the concave part is random.

7. The optical element according to claim 3, wherein
the fine concavo-convex structure is formed so that at least one of a shape and a size of the concave part is random.

8. The optical element according to claim 4, wherein the fine concavo-convex structure is formed so that at least one of a shape and a size of the concave part is random.

9. An anti-reflection structure comprising a fine concavo-convex structure comprising a convex part in which an edge line part runs continuously in a net-like manner, in which at least a part of the edge line part is formed to be deeper in a depth direction of the concave part than an edge line intersection part at which the edge line part intersects.

10. The anti-reflection structure according to claim 9, wherein
a concave part deepest portion being a deepest in the concave part is formed to be deeper than an edge line part deepest portion of being a deepest in the edge line part.

11. The anti-reflection structure according to claim 9, wherein
in the fine concavo-convex structure, a maximum value of a distance of center parts of the two concave parts adjacent in a direction connecting the two adjacent edge line intersection parts is smaller than visible light wavelength.

12. The anti-reflection structure according to claim 10, wherein
in the fine concavo-convex structure, a maximum value of a distance of center parts of the two concave parts adjacent in a direction connecting the two adjacent edge line intersection parts is smaller than visible light wavelength.

13. The anti-reflection structure according to claim 9, wherein
the fine concavo-convex structure is formed so that at least one of a shape and a size of the concave part is random.

14. A manufacturing method of an optical element, comprising:
a process to cover an optical surface with a mask having a plurality of openings;
a process to form a plurality of concave parts on the optical surface corresponding to the openings by isotropic etching; and
a process to apply etching further so that, in a convex part in which an edge line part runs continuously and encloses the concave part, at least a part of the edge line part becomes deeper in a depth direction of the concave part than an edge line intersection part at which the edge line part intersects.

15. The manufacturing method of an optical element according to claim 14, wherein
etching is applied so that a concave part deepest portion being a deepest in the concave part becomes deeper than an edge line part deepest portion of being a deepest in the edge line part.

16. The manufacturing method of an optical element according to claim 14, wherein
a maximum value of a distance of center parts of the two concave parts adjacent in a direction connecting the two adjacent edge line intersection parts is smaller than visible light wavelength.

17. The manufacturing method of an optical element according to claim 15, wherein
a maximum value of a distance of center parts of the two concave parts adjacent in a direction connecting the two adjacent edge line intersection parts is smaller than visible light wavelength.

18. The manufacturing method of an optical element according to claim 14, wherein
the fine concavo-convex structure is formed so that at least one of a shape and a size of the concave part is random.

19. The manufacturing method of an optical element according to claim 15, wherein
the fine concavo-convex structure is formed so that at least one of a shape and a size of the concave part is random.

20. The manufacturing method of an optical element according to claim 16, wherein
the fine concavo-convex structure is formed so that at least one of a shape and a size of the concave part is random.
